(19) United States
(12) Patent Application Publication
(10) Pub. No.: US 2006/0127751 A1
(43) Pub. Date: Jun. 15, 2006

(54) Lithium rechargeable battery

(76) Inventor: Soon Ki Woo, Kiheung-eup (KR)

Correspondence Address: H.C. PARK & ASSOCIATES, PLC, 8500 LEESBURG PIKE, SUITE 7500, VIENNA, VA, 22182, US

(21) Appl. No.: 11/287,375

(22) Filed: Nov. 28, 2005

(30) Foreign Application Priority Data
Nov. 29, 2004 (KR) 10-2004-0098871

(51) Int. Cl. H01M 4/02; H01M 2/26; H01M 4/58; H01M 4/40; H01M 4/66

(52) U.S. Cl. 429/128; 429/94; 429/211; 429/231.95; 429/231.4; 429/245; 429/161

(57) ABSTRACT

A lithium rechargeable battery with an electrode assembly comprising at least two positive electrode plates with electrode tabs coupled to each positive electrode plate, at least two negative electrode plates with electrode tabs coupled to each negative electrode plate, separators interposed between each positive and negative electrode pair, and the electrode assembly being formed by winding a layered structure of the electrode plates and separators into a jelly roll shape. The electrode plates are partially coated with electrode active material capable of reversible lithium ion intercalation and de-intercalation. The tabs coupled to the positive electrode plates are coupled with a first terminal of the battery, and the tabs coupled to the negative electrode plates are coupled with a second terminal of the battery.

### CROSS REFERENCE TO RELATED APPLICATION

This application claims priority to and the benefit of Korean Patent Application No. 10-2004-0098871, filed on Nov. 29, 2004, which is hereby incorporated by reference for all purposes as if fully set forth herein.

### BACKGROUND OF THE INVENTION

1. Field of the Invention

The present invention relates to a lithium rechargeable battery, and in particular, to a lithium rechargeable battery with reduced internal resistance for improved charge/discharge efficiency.

2. Discussion of the Background

As portable electronic devices become smaller and lighter, the batteries used to power the devices must also become smaller while still maintaining a high capacity. For example, a lithium ion rechargeable battery can have a drive voltage of 3.6 V or more, which is three times higher than the drive voltage of a traditional nickel-cadmium (Ni—Cd) battery or nickel-metal hydride (Ni-MH) battery used as a power source for a portable electronic device. Further, a lithium ion rechargeable battery has relatively high energy density per unit mass.

Lithium rechargeable batteries generate electric energy by oxidation and reduction reactions resulting from intercalation of lithium ions at a positive electrode and de-intercalation of lithium ions at a negative electrode. A lithium rechargeable battery uses materials capable of reversible lithium ion intercalation and de-intercalation as active materials for a positive electrode and a negative electrode. An organic electrolyte or polymer electrolyte is injected into the gap between the positive electrode and the negative electrode to form a lithium rechargeable battery.

Lithium-containing metal oxides such as lithium cobalt oxide (LiCoO₂), lithium nickel oxide (LiNiO₂) and lithium manganese oxide (LiMnO₂) may be used as positive electrode materials of lithium rechargeable batteries. Lithium metal or lithium alloys can be used as negative electrode active materials of lithium rechargeable batteries. However, when lithium metal is used as negative electrode active material, formation of dendrites between the electrodes may result in explosion due to short circuit of the battery. Therefore, lithium metal can be substituted with carbonaceous materials such as amorphous carbon or crystalline carbon. Lithium rechargeable batteries are provided in various shapes and typical examples thereof include cylindrical, prismatic and pouch type batteries.

FIG. 1 shows an exploded perspective view of a conventional lithium rechargeable battery.

A lithium rechargeable battery may be formed by introducing an electrode assembly 12, which includes a positive electrode 13, a negative electrode 15 and a separator 14, into a can 10 along with an electrolyte, and then sealing the top of the can 10 with a cap assembly 20. The cap assembly 20 includes a cap plate 40, an electrode terminal 30 inserted through hole 41 of the cap plate 40, an insulating plate 50 disposed on the bottom of the cap plate 40, and a terminal plate 60 disposed on the bottom of the insulating plate 50 and electrically coupled with the electrode terminal 30. Additionally, the cap assembly 20 is insulated from the electrode assembly 12 by a separate insulation case 70 coupled with the top opening of the can 10 to seal the can 10.

The electrode terminal 30 is inserted into the terminal through hole 41, which is formed at the center of the cap plate 40. When the electrode terminal 30 is inserted through hole 41, a cylindrical gasket 35 is coupled to the outer surface of the electrode terminal 30 to provide electric insulation between the electrode terminal 30 and the cap plate 40. After the cap assembly is mounted on the top of the can 10, the electrolyte is injected through an inlet 42, and then the inlet 42 is sealed with a stopper 43.

The electrode terminal 30 can be electrically coupled with either the second electrode tab 17 of the second electrode 15 or the first electrode tab 16 of the first electrode 13 through the terminal plate 60. A portion of the first electrode tab 16 and the second electrode tab 17 are enclosed with an insulation tape 18 to prevent short circuit between the first electrode 13 and the second electrode 15. The electrode tab that is not electrically coupled with the electrode terminal 30 is coupled with the bottom surface of the cap plate 40.

When the first electrode 13 is coupled with the cap plate 40 and the second electrode 15 is coupled with the electrode terminal 30, the first electrode 13 forms a positive electrode and the second electrode 16 forms an negative electrode in the lithium rechargeable is battery. Thus, the electrode terminal 30 functions as a negative electrode, while the can 10 and the cap plate 40 function as a positive electrode.

FIG. 2 shows an exploded perspective view of an electrode assembly of a conventional lithium rechargeable battery.

An electrode assembly 12 is formed by winding the first electrode plate 13 and the second electrode plate 15, with the separator 14 interposed between both electrode plates. At least one surface of each of the first electrode plate 13 and the second electrode plate 15 is coated with electrode active material. Additionally, each of the first electrode tab 16 and the second electrode tab 17 are coupled with a portion of each electrode that is not coated with electrode active materials.

In the lithium rechargeable battery as described above, the first electrode plate 13 and second electrode plate serve both as support for electrode active materials and as a path through which electric current flows. The electrode assembly 12 is manufactured by winding the first electrode plate 13, the second electrode plate 15, and the separator 14 in the shape of a jelly-roll. Although such manufacturing methods are advantageous in terms of productivity and production cost, there is a limitation in providing a rechargeable battery having low internal resistance because of difficulty in decreasing the resistance along the longitudinal direction of an electrode plate.

### SUMMARY OF THE INVENTION

This invention provides a lithium rechargeable battery that has improved charge/discharge efficiency and permits rapid charge/discharge due to reduced internal resistance.

Additional features of the invention will be set forth in the description which is follows, and in part will be apparent from the description, or may be learned by practice of the invention.

The present invention discloses a an electrode assembly for a lithium rechargeable battery, including a first positive electrode plate, a second positive electrode plate, a first positive electrode plate tab coupled with the first positive electrode plate, a second positive electrode plate tab coupled with the second positive electrode plate and coupled with the first positive electrode plate tab, the second positive electrode tab for coupling the positive electrode to a first terminal of the lithium rechargeable battery, a first negative electrode plate, a second negative electrode plate, a first negative electrode plate tab coupled with the first negative electrode plate, a second negative electrode plate tab coupled with the second negative electrode plate and coupled with the first negative electrode plate tab, the second negative electrode tab for coupling the negative electrode to a second terminal of the lithium rechargeable battery, a first separator interposed between the first positive electrode plate and the first negative electrode plate, a second separator interposed between the second positive electrode plate and the second negative electrode plate. Further, the electrode assembly is formed by winding the electrode plates and separators into ajelly-roll shape.

The present invention also discloses a lithium rechargeable battery including a first terminal, a first positive electrode plate, a second positive electrode plate, a first positive electrode plate tab coupled with the first positive electrode plate, a second positive electrode plate tab coupled with the second positive electrode plate, the first positive electrode plate tab, and the first terminal, a second terminal, a first negative electrode plate, a second negative electrode plate, a first negative electrode plate tab coupled with the first negative electrode plate, and a second negative electrode plate tab coupled with the second negative electrode plate, the first negative electrode plate tab, and the second terminal. Further, the first positive electrode plate, the second positive electrode plate, the first negative electrode plate, and the second negative electrode plate are partially coated with electrode active material capable of reversible lithium ion intercalation and de-intercalation.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows an exploded perspective view of a conventional lithium rechargeable battery.

FIG. 2 shows an exploded perspective view of an electrode assembly of a conventional lithium rechargeable battery.

FIG. 3 shows an exploded perspective view of a first exemplary embodiment of the electrode assembly according to the present invention.

FIG. 4 shows an exploded perspective view of a second exemplary embodiment of the electrode assembly according to the present invention.

FIG. 5 shows an exploded perspective view of a third exemplary embodiment of the electrode assembly according to the present invention.

FIG. 6 shows an exploded perspective view of a lithium rechargeable battery with is the electrode assembly of the third exemplary embodiment according to the present invention.

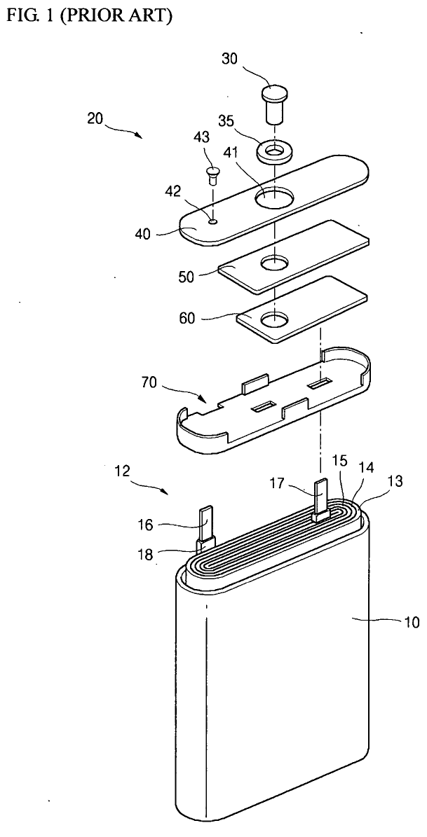

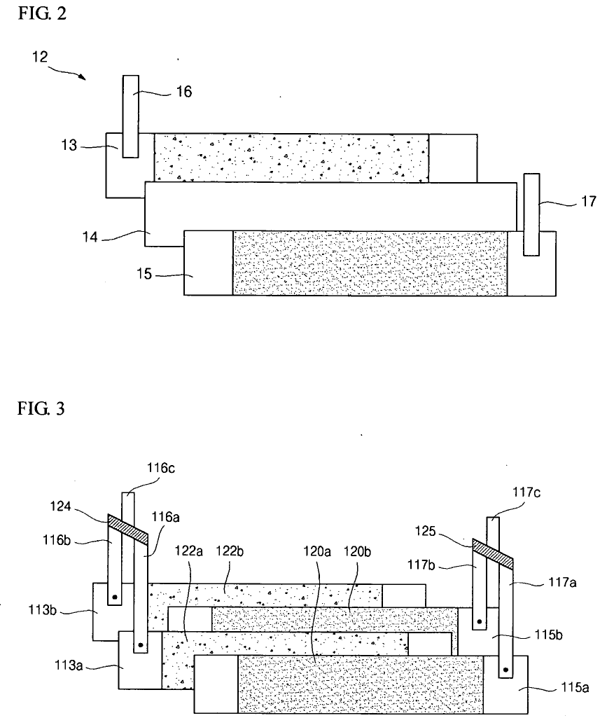

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Further, like numbers in the figures refer to the same components to avoid repetitious description.

FIG. 3 shows an exploded perspective view of a first exemplary embodiment of the electrode assembly according to the present invention.

Referring to FIG. 3, the first embodiment of the electrode assembly according to the present invention may be formed by winding two first electrode plates 113a and 113b two second electrode plates 115a and 115b, with a separator (not shown) interposed between first electrode plate 113a and second electrode plate 115a, and another separator (not shown) interposed between first electrode plate 113b and second electrode plate 115b, into a jelly roll.

The electrode assembly may include one or more additional layers of electrode plates where an additional layer includes an additional first electrode plate, an additional second electrode plate, and an additional separator interposed between the first electrode plate and second electrode plate. Further, an additional first electrode plate is fabricated and installed as described for the first electrode plates 113a and 113b, and a second electrode plate is fabricated and installed as described for second electrode plates 115a and 115b.

The separators (not shown) prevent a short circuit by separating the first electrode plate 113a from the second electrode plate 115a, and by separating the first electrode plate 113b from the second electrode plate 115b. Further, the separators provide a flow path for lithium ions. The separators may be formed of, for example, a polymer film such as polyolefin, polyethylene film, polypropylene films, multilayer films thereof, a fine porous film, a woven webs or a non-woven webs.

At least one surface of the first electrode plate 113a is coated with electrode active material 122a. At least one surface of the first electrode plate 113b is coated with electrode active material 122b. Additionally, a surface of the uncoated portion of the first electrode plate 113a is coupled with a first electrode tab 116a. Additionally, a surface of the uncoated portion of the first electrode plate 113b is coupled with a first electrode tab 116b.

Similarly, at least one surface of the second electrode plate 115a is coated with electrode active material 120a. At least one surface of the second electrode plate 115b is coated with electrode active material 120b. Additionally, a surface of the uncoated portion of the second electrode plate 115a is coupled with a second electrode tab 117a. Additionally, a surface of the uncoated portion of the second electrode plate 115b is coupled with a second electrode tab 117b.

The first electrode plates 113a and 113b may function as positive electrode plates or negative electrode plates. The second electrode plates 115a and 115b may function as positive electrode plates or negative electrode plates, and will function as electrode plates with opposite polarity as the first electrode plates.

The positive electrode plates, which may be either the first electrode plates 113a and 113b or the second electrode plates 115a and 115b, may be made of stainless steel, nickel, titanium or alloys thereof, or stainless steel that has been surface-treated with carbon, nickel, titanium or silver. The positive electrode plates may also be made of aluminum or aluminum alloy.

The negative electrode plates, which may be either the first electrode plates 113a and 113b or the second electrode plates 115a and 115b, may be made of stainless steel, nickel, titanium or alloys thereof, or copper or stainless steel that has been surface-treated with carbon, nickel, titanium or silver. The negative electrode plates may also be made of copper or copper alloy.

The electrode active material 120a coated on the second electrode plate 115a, the electrode active material 120b coated on the second electrode plate 115b, the electrode active material 122a coated on the first electrode plate 113a, and the electrode active material 122b coated on the first electrode plate 113b may be positive electrode active material or negative electrode active material. The positive electrode active material and negative electrode active material should be capable of reversible lithium ion intercalation/deintercalation.

The positive electrode active material may be, for example, lithium-containing transition metal oxides or lithium chalcogenide compounds, and typical examples thereof include LiCoO₂, LiNiO₂, LiMnO₂, LiMn₂O₄, or LiNi_{1-x-y}CoₓM_{y}O₂, where 0≦x≦1, 0≦y≦1, 0≦x+y≦1, and M is a metal such as Al, Sr, Mg and La. The negative electrode active material may be, for example, carbonaceous materials such as crystalline carbon, amorphous carbon, carbon composite and carbon fiber, lithium metal or lithium alloys.

The first electrode tab 116a is coupled with the uncoated portion of the first electrode plate 113a. The first electrode tab 116b is coupled with the uncoated portion of the first electrode plate 113b. The second electrode tab 117a is coupled with the uncoated portion of the second electrode plate 115a. The second electrode tab 1171b is coupled with the uncoated portion of the second electrode plate 115b. The electrode tabs may be coupled with the electrode plates through various methods including spot welding, laser welding and ultrasonic welding, or using a conductive adhesive. The conductive adhesive may be a conductive paste that is prepared by uniformly mixing a conductive metal powder, such as silver or nickel, with carbon and dispersing the mixture into a synthetic resin or a synthetic rubber. The synthetic resin may have excellent adhesive properties and may be an epoxy resin, acryl resin, or modified urethane resin, for example.

The first electrode tab 116a and first electrode tab 116b, each coupled with one of the first electrode plates 113a and 113b, are coupled together in parallel. The second electrode tab 117a and second electrode tab 117b, each coupled with one of the second electrode plates 115a, 115b, are coupled together in parallel.

As described above, the electrode assembly according to the present invention includes multiple sets of electrode plates having different polarity, where each set includes at least two electrode plates for each electrode polarity. Electrode tabs are individually coupled with each of the electrode plates. Additionally, the electrode tabs coupled with electrode plates of common polarity are coupled together in parallel. Thus, electric resistance of each electrode is calculated using a parallel resistance equation (1).
1/Rᵢ=1/R₁+1/R₂+ . . . +1/Rₙ (1)

In equation 1, Rᵢ represents the internal electrical resistance in a positive electrode. R₁ represents the electrical resistance of a first positive electrode plate and the electrode tab coupled with the first positive electrode plate. R₂ represents the electrical resistance of a second positive electrode plate and the electrode tab coupled with the second positive electrode plate. Rₙ represents the electrical resistance of an n-th positive electrode plate and the electrode tab coupled with the n-th positive electrode plate. Furthermore, equation 1 may also be used to calculate the internal electrical resistance in a negative electrode, where R₁, R₂, and Rₙ represent the electrical resistance of a first, second, and n-th negative electrode plate and the electrode tabs coupled with the first, second, and n-th negative electrode plates.

Due to the benefit of coupling the electrode tabs of a single polarity in parallel, the internal electrical resistance, Rᵢ, of an electrode is lower than any individual resistances R₁, R₂, . . . Rₙ. Thus, the internal resistance of a rechargeable battery is decreased.

The electrical resistance of an electrode plate and electrode tab, Rₙ, can also be reduced over the conventional electrode assembly. Electric resistance is proportional to the length of a conductor, as expressed by the following equation (2).

$$R = ρ \frac{L}{S} \qquad ( 2 )$$

In equation (2), R represents resistance (Ω) of a conductor, ρ represents specific resistance of the conductor, L represents the length (m) of a conductor, and S represents cross section (m²). Thus, it is possible to decrease the length of electrode plates along the longitudinal direction compared to conventional positive electrode plates and negative electrode plates having substantially the same capacity. Since the electrode assembly according to the present invention uses at least two positive electrode plates and at least two negative electrode plates, the length of each electrode plate is less than in an electrode assembly with only one positive electrode plate and one negative electrode plate. Therefore, because the electrode plates forming the electrode assembly according to the present invention are shorter, electric resistance in each electrode plate is reduced, thus reducing Rₙ for the electrode plate and electrode tab. Finally, by reducing Rₙ the internal resistance Rᵢ is reduced.

As shown in FIG. 3, the first electrode tabs 116a and 116b may be electrically coupled together through a separated conductive interconnection 124. Another electrode tab 116c may be coupled with the interconnection 124 to extend the interconnection. The conductive interconnection 124 and the electrode tab 116c may be electrically coupled together by a welding process such as spot welding, laser welding and ultrasonic welding or by using a conductive adhesive.

Similarly, the second electrode tabs 117a and 117b may be electrically coupled together through a separated conductive interconnection 125. Another electrode tab 117c may be coupled with the interconnection 125 to extend the interconnection.

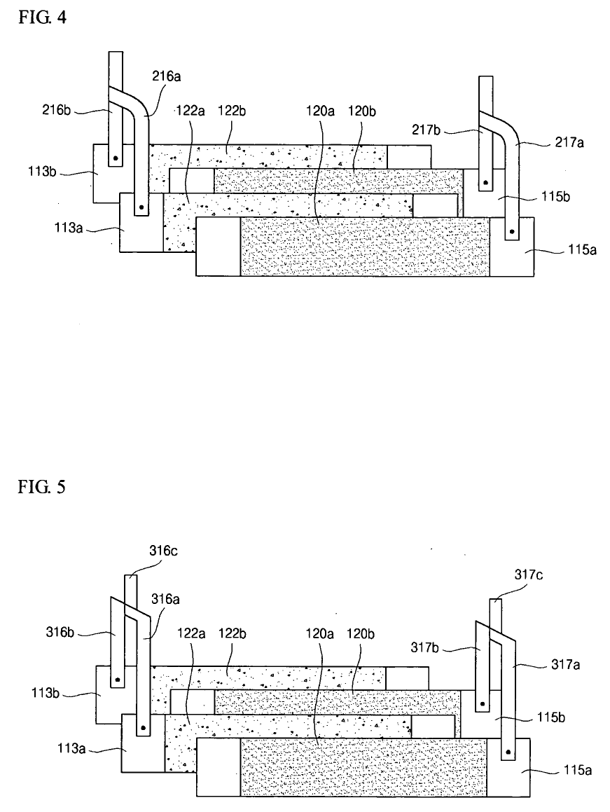

FIG. 4 shows an exploded perspective view of a second exemplary embodiment of the electrode assembly according to the present invention.

As shown in FIG. 4, one electrode tab 216a of the first electrode tabs 216a and 216b may be bent and coupled to the other first electrode tab 216b without using a separate conductive interconnection interposed between the two first electrode tabs. Then, the first electrode tab 216b can be extended sufficiently to electrically couple with a terminal. Additionally, one electrode tab 217a of the second electrode tabs 217a and 217b may be bent and coupled to the other second electrode tab 217b without using a separate conductive interconnection interposed between the two second electrode tabs. Then, the second electrode tab 217b can be extended to electrically couple with a terminal. According to the second embodiment as shown in FIG. 4, there is no need for a separate conductive interconnection nor a separate electrode tab for coupling the electrode tabs with a terminal, thus simplifying the manufacturing process for the electrode assembly.

FIG. 5 shows an exploded perspective view of a third exemplary embodiment of the electrode assembly according to the present invention.

As shown in FIG. 5, one electrode tab 316a of the first electrode tabs 316a and 316b may be bent and welded to another electrode tab 316b without using a separate conductive interconnection coupled with the first electrode tabs. Then, a separate electrode tab 316c for electrically coupling first electrode tab 316a and first electrode tab 316b with a terminal may be coupled with the coupled first electrode tabs. Similarly, one electrode tab 317a of the second electrode tabs 317a and 317b may be bent and welded to another second electrode tab 317b without using a separate conductive interconnection coupled with the second electrode tabs. Then, a separate electrode tab 317c for electrically coupling second electrode tab 317a and second electrode tab 317b with a terminal may be coupled with the coupled second electrode tabs.

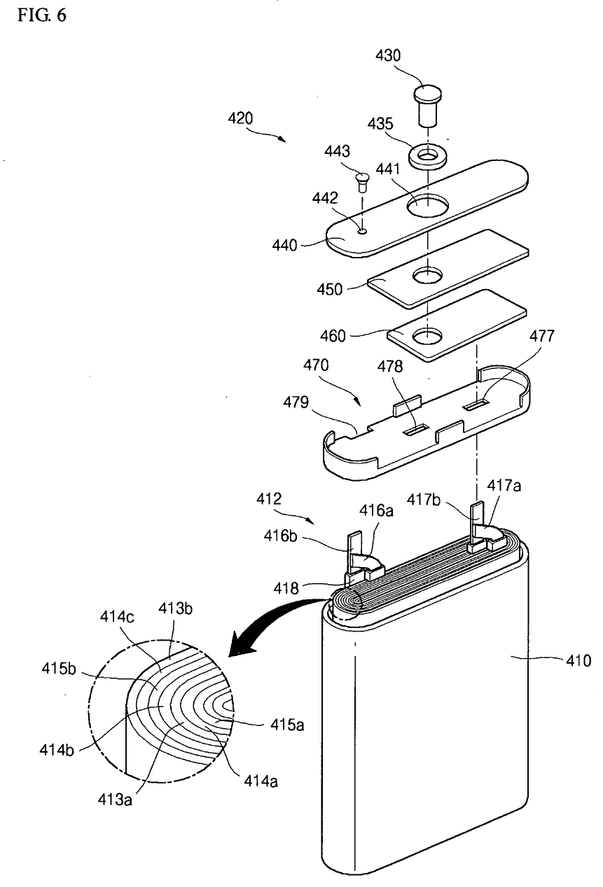

FIG. 6 shows an exploded perspective view of a lithium rechargeable battery incorporating the third embodiment of the electrode assembly according to the present invention.

A lithium rechargeable battery according to the present invention comprises a can 410, an electrode assembly 412 contained in the can 410, and a cap assembly 420 that is coupled to the top of the can 410.

The can 410 can be made in an approximately rectangular shape with an open top, and of a metal that is light and soft, such as aluminum, aluminum alloy, or stainless steel. The can 410 may function as a terminal.

The electrode assembly 412 includes first electrode plates 413a and 413b, second electrode plates 415a and 415b, and separators 414a and 414b. The first electrode plates 413a and 413b and the second electrode plates 415a and 415b may be layered alternately with the separators 414a and 414b interposed between both electrode plates and then may be wound into a jelly roll. First electrode tabs 416a and 416b and second electrode tabs 417a and 417b are coupled with the first electrode plates 413a and 413b and the second electrode plates 415a and 415b, respectively. They may be coupled through various methods such as spot welding, laser welding, ultrasonic welding, or with a conductive adhesive. One first electrode tab 416a can be bent and welded to a second first electrode tab 416b. Then, the first electrode tab 416b can be extended and used for electrically coupling the electrode plate with a terminal. Similarly, one second electrode tab 417a can be bent and welded to a second electrode tab 417b. Then, the second electrode tab 417b can be extended and used to electrically couple the electrode plate with a terminal.

The first electrode plates 413a and 413b and the second electrode plates 415a and 415b have different polarity and may be used as positive electrode or negative electrode. At least one surface of each of the first electrode plates 413a and 413b and the second electrode plates 415a and 415b can be coated with a layer of electrode active material. For example, the plates included in the positive electrode can have a layer of positive electrode active material, and the plates included in the negative electrode can have a layer of negative electrode active material. The layer of electrode active material may be formed by mixing an electrode active material and a binder with a solvent to be dispersed therein. A conductive agent may also be added to the solvent. The resulting slurry of electrode active material is then coated on a surface of an electrode plate, followed by drying and rolling the slurry. The first electrode plates 413a and 413b and the second electrode plates 415a and 415b are coated with a layer of positive electrode active material or negative electrode active material, according to their respective polarity.

The separator 414a prevents short circuiting between the first electrode plate 413a and the second electrode plate 415a. The separator 414b prevents short circuiting between the first electrode plate 413a and the second electrode plate 415b. The separator 414c prevents short circuiting between first electrode plate 413b and second electrode plate 415b. Further, the separators 414a and 414b provide a flow path for lithium ions. The separators 414a, 414b, and 414c may be formed of a polymer film such as polyolefin, polyethylene film, polypropylene films, multilayer films thereof, a fine porous film, a woven webs or a non-woven webs.

The cap assembly 420 coupled to the top of the can 410 includes a cap plate 440, an insulating plate 450, a terminal plate 460 and an electrode terminal 430. The cap plate 440 is formed of a metal plate having a size and shape corresponding to the top opening of the can 410. The cap plate 440 includes a terminal through hole 441 having a predetermined size at the center thereof and an electrolyte inlet 442 at one side. An electrolyte is injected through the electrolyte inlet 442 and then the electrolyte inlet 442 is sealed by joining it with a stopper 443.

An electrode terminal 430 is inserted into the terminal through hole 441. Additionally, a cylindrical gasket 435 is disposed on the outer circumferential surface of the electrode terminal 430 to electrically insulate the cap plate 440 from the electrode terminal 30. The insulating plate 450 is disposed at the bottom surface of the cap plate 440 and the terminal plate 460 is disposed at the bottom surface of the insulating plate 450. The bottom surface of the electrode terminal 430 is electrically coupled with the terminal plate 460, while the insulating plate 450 insulates terminal plate 460 from cap plate 440.

A first electrode tab 416b drawn as electrode tab for making electric connection with a terminal is coupled with the bottom surface of the cap plate 440, and a second electrode tab 417b drawn as electrode tab for making electric connection with a terminal is welded to the terminal plate 460. The first electrode tabs 416a and 416b and the second electrode tabs 417a and 417b may be formed of nickel, nickel alloy, aluminum or aluminum alloy. A portion of each of the first electrode tabs 416a and 416b and the second electrode tabs 417a and 417b exposed out of the electrode assembly 413, are enclosed with an insulation tape 418 in order to prevent short circuit between electrodes.

Arranged on the top of the electrode assembly 412 is an insulation case 470 that insulates the electrode assembly 412 from the cap assembly 420 and fixes the positions of the electrode assembly 412, first electrode tabs 416a and 416b and the second electrode tabs 417a and 417b. The insulation case 470 further includes an electrode tab drawing port 477 through which the second electrode tab 417b can couple with a terminal, an electrode tab drawing groove 479 through which the first electrode tab 416b can couple with a terminal, and an electrolyte introduction port 478 through which the electrolyte injected via the electrolyte inlet 442 can pass into the electrode assembly 412. To prevent short circuiting between electrodes, the electrode tab having polarity different from that of the can 410 can be drawn through the electrode tab drawing port 477. The insulation case 470 can be formed of polymer resins having insulation property such as polypropylene.

As can be seen from the foregoing, the lithium rechargeable battery according to the present invention, which includes at least two first electrode plates and at least two second electrode plates, each electrode plate having an electrode tab coupled thereto, has decreased internal resistance, thereby improving charge/discharge efficiency and permitting accelerated charge/discharge.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An electrode assembly for a lithium rechargeable battery, comprising:
a first positive electrode plate;
a second positive electrode plate;
a first positive electrode plate tab coupled with the first positive electrode plate;
a second positive electrode plate tab coupled with the second positive electrode plate, the first positive electrode plate tab and the second positive electrode plate tab being coupled with a first terminal of the lithium rechargeable battery;
a first negative electrode plate;
a second negative electrode plate;
a first negative electrode plate tab coupled with the first negative electrode plate;
a second negative electrode plate tab coupled with the second negative electrode plate, the first negative electrode plate tab and the second negative electrode plate tab being coupled with a second terminal of the lithium rechargeable battery;
a first separator interposed between the first positive electrode plate and the first negative electrode plate; and
a second separator interposed between the second positive electrode plate and the second negative electrode plate,
wherein the electrode plates and separators are wound in a jelly-roll shape.

2. The electrode assembly of claim 1, further comprising:
electrode active material coated on the first positive electrode plate, the second positive electrode plate, the first negative electrode plate, and the second negative electrode plate.

3. The electrode assembly of claim 2, wherein the electrode active material is capable of reversible lithium ion intercalation and de-intercalation.

4. The electrode assembly of claim 3, wherein the electrode active material coated on the first positive electrode plate comprises lithium-containing transition metal oxides or lithium chalcogenide compounds.

5. The electrode assembly of claim 3, wherein the electrode active material coated on the first negative electrode plate comprises crystalline carbon, amorphous carbon, carbon composite, carbon fiber, lithium metal, or a lithium alloy.

6. The electrode assembly of claim 3, further comprising:
a positive conductive interconnection,
wherein the positive conductive interconnection couples the first positive electrode plate tab and the second positive electrode plate tab with the first terminal.

7. The electrode assembly of claim 3, further comprising:
a third positive electrode tab,
wherein the third positive electrode tab couples the first positive electrode plate tab and the second positive electrode plate tab with the first terminal.

8. The electrode assembly of claim 3, further comprising:
a negative conductive interconnection,
wherein the negative conduction interconnection couples the first negative electrode plate tab and the second negative electrode plate tab with the second terminal.

9. The electrode assembly of claim 3, further comprising:
a third negative electrode tab,
wherein the third negative electrode tab couples the first negative electrode plate tab and the second negative electrode plate tab with the second terminal.

10. The electrode assembly of claim 3, wherein the first separator or the second separator comprises polyolefin, polyethylene film, or polypropylene film.

11. The electrode assembly of claim 3, wherein the first positive electrode plate comprises stainless steel, nickel, aluminum, titanium, or an alloy thereof.

12. The electrode assembly of claim 3, wherein the first negative electrode plate comprises stainless steel, nickel, copper, titanium, or an alloy thereof.

13. The electrode assembly of claim 3, wherein the first positive electrode plate tab is coupled with the first positive electrode plate by spot welding, laser welding, ultrasonic welding, or with a conductive adhesive.

14. The electrode assembly of claim 12, wherein the conductive adhesive comprises a silver paste or a nickel paste.

15. The electrode assembly of claim 3, wherein the first negative electrode plate tab is coupled with the first negative electrode plate by spot welding, laser welding, ultrasonic welding, or with a conductive adhesive.

16. The electrode assembly of claim 15, wherein the conductive adhesive comprises a silver paste or a nickel paste.

17. The electrode assembly of claim 3, wherein the first positive electrode plate tab comprises nickel, nickel alloy, aluminum, or aluminum alloy.

18. The electrode assembly of claim 3, wherein the first negative electrode plate tab comprises nickel, nickel alloy, aluminum, or aluminum alloy.

19. A lithium rechargeable battery, comprising:
a first terminal;
a first positive electrode plate;
a second positive electrode plate;
a first positive electrode plate tab coupled with the first positive electrode plate;
a second positive electrode plate tab coupled with the second positive electrode plate, the first positive electrode plate tab, and the first terminal;
a second terminal;
a first negative electrode plate;
a second negative electrode plate;
a first negative electrode plate tab coupled with the first negative electrode plate; and
a second negative electrode plate tab coupled with the second negative electrode plate, the first negative electrode plate tab, and the second terminal,
wherein the first positive electrode plate, the second positive electrode plate, the first negative electrode plate, and the second negative electrode plate are partially coated with electrode active material capable of reversible lithium ion intercalation and de-intercalation.

20. The lithium rechargeable battery of claim 19, further comprising:
a first separator interposed between the first positive electrode plate and the first negative electrode plate; and
a second separator interposed between the second positive electrode plate and the second negative electrode plate,
wherein the first positive electrode plate, the first negative electrode plate, and the first separator are wound together with the second positive electrode plate, the second negative electrode plate, and the second separator in a jelly-roll shape.
